(19) United States
(12) Patent Application Publication
(10) Pub. No.: US 2004/0217707 A1
(43) Pub. Date: Nov. 4, 2004

(54) Transparent electrode structure for plasma display panel

(76) Inventors: Hsu-Pin Kao, Ping Chen City (TW); Sheng-Wen Hsu, Taipei (TW); Ching-Chung Cheng, Ping Chen City (TW)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/663,262

(22) Filed: Sep. 16, 2003

(30) Foreign Application Priority Data
May 2, 2003 (TW) 92112175

(51) Int. Cl. H01J 17/49

(52) U.S. Cl. 313/584; 313/582

(57) ABSTRACT

The present invention provides a transparent electrode structure for a plasma display panel. The transparent electrode structure has a body and two connecting parts. This body is connected to the branches of the comb electrode through the two connecting parts to make the body protrud toward the center of the luminant unit. A hollow exists between the transparent electrode and the main line of the comb electrode.

### FIELD OF THE INVENTION

The present invention relates to a plasma display panel (PDP), and more particularly to a transparent electrode structure that can reduce power consumption.

### BACKGROUND OF THE INVENTION

User demand for entertainment equipment is particularly high as a result of the rapid development of multimedia applications. Conventionally, the cathode ray tube (CRT) display, which is a type of monitor, is commonly used. However, the cathode ray tube display does not meet the needs of multimedia technology because of the large volume thereof. Therefore, many flat panel display techniques such as liquid crystal display (LCD), plasma display panel (PDP), and field emission display (FED) have been recently developed. Of these techniques, the plasma display panel (PDP) is attracting attention in the field of displays as a full-color display apparatus having a large size display area and is especially popular when utilized for a large size television or an outdoor display panel.

A color PDP is a display in which ultraviolet rays are produced by gas discharge to excite phosphorus so that visible light is emitted therefrom to perform a display operation. Depending upon a discharge mode, the color PDP is classified as an alternating current (AC) or a direct current (DC) type. In the AC-type PDP, an electrode is covered with a protective layer. The AC-type PDP has characteristics such as an inherent long life and a high brightness. Therefore, the AC-type PDP is commonly superior to the DC-type PDP in luminance, luminous efficiency and lifetime.

Generally, a 3-electrode-type PDP including a common electrode, a scan electrode (X electrode and Y electrode) and an address electrode is employed in the AC-type PDP. The 3-electrode-type is directed to a surface discharge-type and is switched or sustained based on a voltage applied to the address electrode installed at a lateral surface of a discharge cell.

FIG. 1 illustrates an electrode structure 100 including common electrodes and scan electrodes located on the up substrate of a conventional PDP. Both the common electrode and the scan electrode include a narrower bus electrode 101 and a wider transparent electrode 102 that are arranged in parallel and perpendicular to the rib 103 located on the down substrate. Moreover, a conventional method for improving the contrast of the conventional PDP is to perform an additional treatment of forming black strips between the non-discharge region and the discharge region.

However, the conventional transparent electrode has a large size that generates a large capacitor. Therefore, a large amount of power is consumed to maintain the voltage applied to the transparent electrode even when the PDP only displays gray. Moreover, the larger size transparent electrode also reduces the efficiency of the PDP while discharging and recharging the transparent electrode.

### SUMMARY OF THE INVENTION

According to the above descriptions, the main object of the present invention is to provide a transparent electrode structure with a smaller size transparent electrode that can reduce power consumption.

Another object of the present invention is to provide a transparent electrode structure. The structure is tortuous and protrudes into the discharging center. In other words, the transparent electrode located near the discharge center is larger in size, which can accumulate the charge to improve the switch efficiency of the PDP.

Yet another object of the present invention is to provide a transparent electrode structure. This structure is designed according to the discharging module of the PDP. Therefore, it can improve the discharging efficiency.

The present invention provides a transparent electrode structure. The transparent electrode structure comprises a body and two connecting parts located in any two adjacent branches of a comb electrode. Accordingly, the body is connected to the two adjacent branches through the two connecting parts to form a protruding structure that protrudes into the discharging center. A hollow region is formed between the transparent electrode, the main line and the two adjacent branches of the comb electrode.

The transparent electrode structure of the present invention is designed according to the discharging mode of the PDP. Therefore, this structure appearance is tortuous and protrudes into the discharging center, which can improve the discharging efficiency. Moreover, a hollow region is formed between the transparent electrode, the main line and the two adjacent branches of the comb electrode, which can reduce the size of the transparent electrode and capacitor.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates an electrode structure of an up substrate of a conventional PDP;

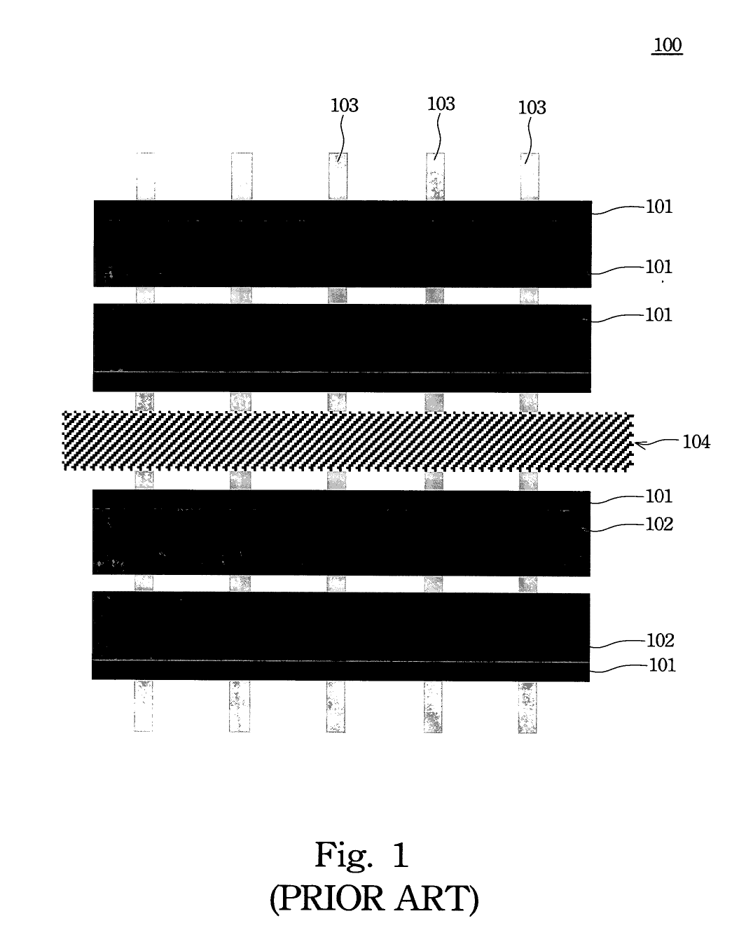

FIG. 2 illustrate a top view schematic diagram of a transparent electrode of a PDP according to the preferred embodiment of the present invention; and

FIG. 3 illustrates an enlarged schematic diagram of a transparent electrode of a PDP according to the preferred embodiment of the present invention.

### DETAILED DESCRIPTION OF THE PREFERRED EMBODIMENT

Without limiting the spirit and scope of the present invention, the transparent electrode structure proposed in the present invention is illustrated with one preferred embodiment. One or ordinary skill in the art, upon acknowledging the embodiment, can apply the transparent electrode structure of the present invention to various plasma display panel. Accordingly, the transparent electrode structure of the present invention is designed according to the discharging mode of the PDP. Therefore, the appearance of the transparent electrode is tortuous and protruding into the discharging center, which can improve the discharging efficiency. The transparent electrode structure of the present invention is not limited by the preferred embodiments described in the following.

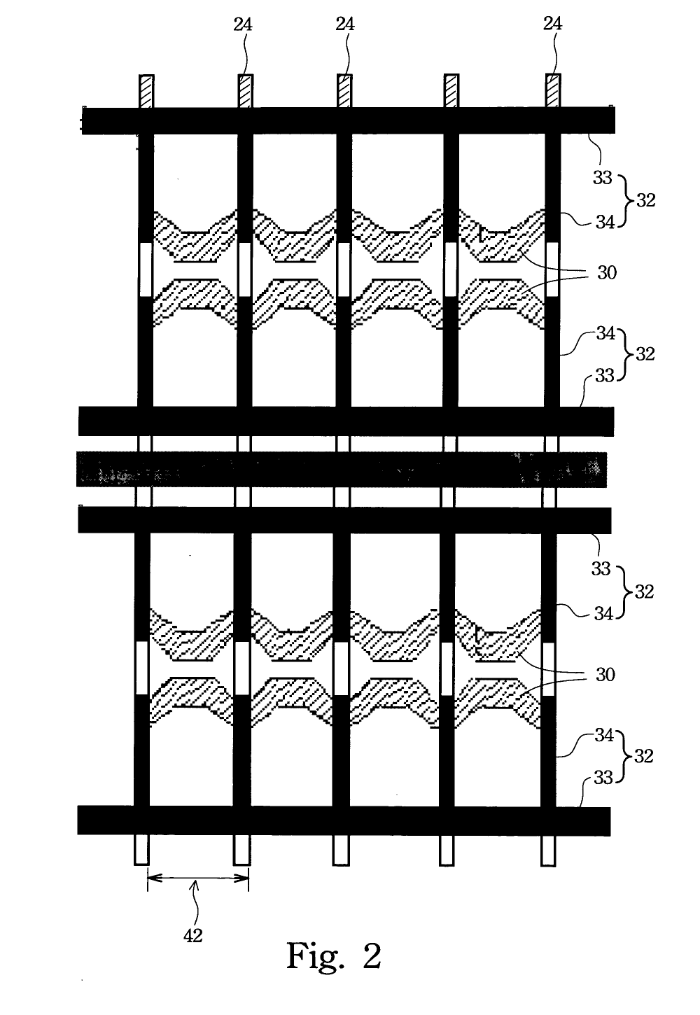

FIG. 2 is a top view schematic diagram of a transparent electrode structure for a plasma display panel according to one preferred embodiment of the present invention. Referring to FIG. 2, the discharge electrode structure comprises a comb electrode 32 and a transparent electrode 30. For a 3-electrode structure, a pair of comb electrodes 32 and a pair of transparent electrodes 30 are used and disposed opposite the luminant units, respectively. The comb electrode 32 includes a main line 33 passing through each of the luminant units in row. A plurality of branches 34 is perpendicularly extended from the main line 33. Generally, the branches 34 are aligned to the barrier ribs 24.

The appearance of the transparent electrode 30 is tortuous and protruding into the discharging center. In other words, the discharge center of each ruminant unit is located between any two adjacent protruding parts of the transparent electrode 30. Therefore, the transparent electrode 30 located near the discharge center is larger in size, which can improve the discharging efficiency. The ITO layer is used to form the transparent electrode.

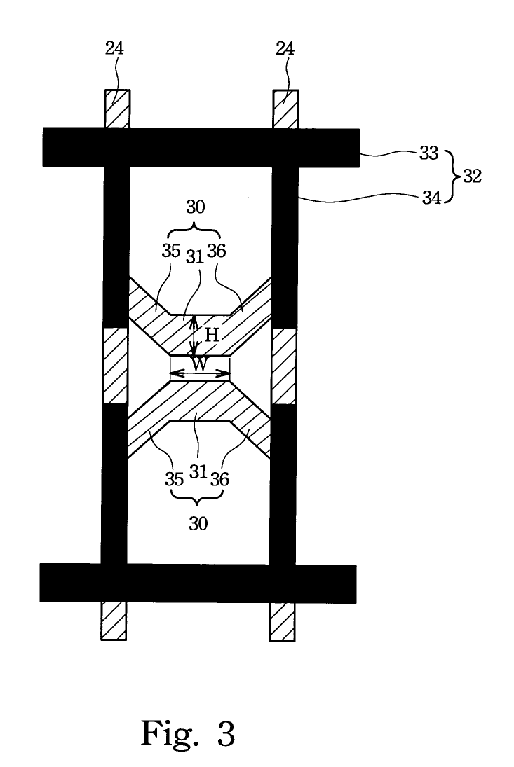

FIG. 3 illustrates an enlarged schematic diagram of the transparent electrode structure composed of the transparent electrode 30 and the comb electrode 32 of the present invention. The rib 24 is used to isolate the ruminant unit. According to the preferred embodiment of the present invention, a pair of transparent electrodes 30 is located near the discharging center. Each transparent electrode 30 is composed of a body 31 and two connecting parts 35 and 36. The appearance of the body 31 is a rectangular according to the preferred embodiment. However, it is noticed that the appearance of the body 31 is not limited by the above rectangular configuration. For example, a segment of a circle can be used as the body 31.

Two bodies 31 respectively belonging to two transparent electrodes 30 are arranged parallel to each other in each ruminant unit. Moreover, the two bodies 31 are located symmetrically around the middle in each ruminant unit. Each body 31 is connected to two adjacent branches 34 of a comb electrode 32 respectively through two connecting parts 35 and 36 that are respectively connected to the two sides of a body 31. In other words, a hollow region exists between the transparent electrode 30, main line 33 and two adjacent branches 34 in each ruminant unit, and the transparent electrode 30 does not directly connect to the main line 33 of the comb electrode 32. Both are connected together through two connecting parts 35 and 36. Therefore, the size of the transparent electrode can be reduced. The inherent capacitor of the transparent electrode is also reduced.

On the other hand, the body 31 is located in the middle between two adjacent branches 34. Two connecting parts 35 and 36 are symmetric to the body 31 and are used to connect the body 31 with the two adjacent branches 34 of the comb electrode 32. The appearance of the transparent electrode 30 is tortuous and protruding into the discharging center. The body 31 is located on the protruding part of the transparent electrode 30. Therefore, a smallest distance exists between the two adjacent bodies 31 in a ruminant unit. Moreover, the two bodies 31 are located near the discharging center, which can improve the discharging efficiency.

In each ruminant unit, the width W of the body 31 is about 20% to 60% of the cell pitch 42. For example, the width W of the body 31 is about 78 μm to 240 μm when the cell pitch 42 is 394 μm. The thickness H of the body 31 is about 5% to 30% of the pixel pitch 40. For example, the thickness H of the body 31 is about 60 μm to 300 μm when the pixel pitch 40 is 1182 μm.

The transparent electrode structure of the present invention can be applied to various plasma display panels. Accordingly, the transparent electrode structure of the present invention is designed according to the discharging mode of the PDP. In other words, the appearance of the transparent electrode is tortuous and protruding into the discharging center, which can improve the discharging efficiency. On the other hand, a hollow region exists between the transparent electrode, main line and two adjacent branches in each ruminant unit. Therefore, the size of the transparent electrode can be reduced. The inherent capacitor of the transparent electrode is also reduced.

As is understood by a person skilled in the art, the foregoing preferred embodiments of the present invention are illustrative of the present invention rather than limiting of the present invention. It is intended that this description cover various modifications and similar arrangements included within the spirit and scope of the appended claims, the scope of which should be accorded the broadest interpretation so as to encompass all such modifications and similar structure.

What is claimed is:

1. A transparent electrode structure for a plasma display panel with a plurality of luminant units between up and down substrates, wherein a comb electrode has a main line across said ruminant units and a plurality of branches perpendicularly extending from said main line and located between said luminant units, said transparent electrode structure comprising:
a plurality of bodies, wherein each of said bodies is located between two corresponding adjacent branches and said main line; and
a plurality of connecting parts respectively located on two sides of said bodies, wherein each of said bodies is connected to two corresponding adjacent branches through two corresponding connecting parts.

2. The transparent electrode structure according to claim 1, wherein each of said bodies protrudes into the discharging center in a ruminant unit.

3. The transparent electrode structure according to claim 1, wherein a distance between the two bodies located in a ruminant unit is maintained.

4. The transparent electrode structure according to claim 1, wherein indium-tin-oxide is used to form said bodies and said connecting parts.

5. The transparent electrode structure according to claim 1, wherein a hollow region exists between the transparent electrode and the comb electrode in each luminant unit.

6. The transparent electrode structure according to claim 1, wherein each of said bodies is rectangular in configuration.

7. The transparent electrode structure according to claim 1, wherein a width of each body is about 20% to 60% of a cell pitch thereof.

8. The transparent electrode structure according to claim 1, wherein a thickness of each body is about 5% to 30% of a pixel pitch thereof.

9. A transparent electrode structure for a plasma display panel with a plurality of luminant units between up and down substrates, wherein a comb electrode has a main line across said ruminant units and a plurality of branches perpendicularly extending from said main line and located between said luminant units, said transparent electrode structure comprising:
a plurality of bodies, wherein each of said bodies is located between two corresponding adjacent branches and said main line; and
a plurality of connecting parts respectively located on two sides of said bodies, wherein each of said bodies is connected to two corresponding adjacent branches through two corresponding connecting parts and protrudes into a discharging center in a ruminant unit.

10. The transparent electrode structure according to claim 9, wherein indium-tin-oxide is used to form said bodies and said connecting parts.

11. The transparent electrode structure according to claim 9, wherein a hollow region exists between the transparent electrode and the comb electrode in each ruminant unit.

12. The transparent electrode structure according to claim 9, wherein each of said bodies is rectangular in configuration.

13. The transparent electrode structure according to claim 9, wherein a width of each body is about 20% to 60% of a cell pitch thereof.

14. The transparent electrode structure according to claim 9, wherein a thickness of each body is about 5% to 30% of a pixel pitch thereof.
